(19) United States
(12) Patent Application Publication
(10) Pub. No.: US 2008/0062270 A1
(43) Pub. Date: Mar. 13, 2008

(54) IMAGING DEVICES AND METHODS

(76) Inventor: David Bernarr Lawson, Tustin, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 11/470,975

(22) Filed: Sep. 7, 2006

(51) Int. Cl. H04N 5/225

(52) U.S. Cl. 348/220.1

(57) ABSTRACT

An analog to digital converter of analog image feeds to simultaneous capture and display of video with simultaneous capture of still images and video images and multiple simultaneous delivery streams. These images may be stored with written records either digitally or in hard copy. Methods for utilizing the simultaneous ability to both capture and display still and video images gives users powerful tools for more efficiently working with the tools, improving performance, storing records, and avoiding liability.

### BACKGROUND

Over the last two decades, digital imaging has become a norm in many industries and consumer imaging products. However, many other industries have been slow to fully embrace and adopt digital imaging product, instead relying on analog imaging products that are the standard tools and instruments in the field. Consequently, the reliance on analog products prevents the capture of the full range advantages and capabilities that changing from an analog data stream to a digital data stream imparts.

### SUMMARY

Briefly stated, an analog to digital converter of analog image feeds that simultaneously captures and displays still images and video images. These images may be stored with written records either digitally or in hard copy. Methods for utilizing the simultaneous ability to both capture and display still and video images gives users powerful tools for more efficiently working with images, improving performance, storing records, and avoiding liability.

According to a feature of the present disclosure, there is provided a device comprising, in combination an analog image signal, an analog to digital converter with at least one still image capturer, with one video image capturer wherein the still images and video images may be independently and simultaneously captured, digitized, and stored.

In addition, according to the present disclosure there is provided a video capture system comprising, in combination, an analog image signal with an analog-to-digital converter with at least one still image capturer and at least one video image capturer. There is one hardware module for still image analog-to-digital conversion and capture, resulting in an at least one digital still image file and at least one hardware module for video image analog-to-digital conversion and capture. This results in at least one digital video image file with at least one display, wherein still images and video images may be independently and simultaneously captured, digitized, and stored and the analog signal is split into a plurality of analog signals that feed each hardware module.

Furthermore, the present disclosure teaches a method comprising a digital-to-analog image converter, in which the converter accepts a analog signal and converts it into digital signals. One digital signal is used for video images and one digital signal is used for still images.

Also, offered for consideration is a system and a business method for storing records for storing at least one image with a record storing at least one image in an archive in which the image is a still image, a video image, or combinations thereof.

Still another business method is to provide digital images from an analog signal to provide a device to receive an analog signal. The device digitizing the analog signal provides simultaneous and independent digital video images and digital still images providing a trigger that causes the device to capture a still image displaying a video image on a display storing the digital video and the digital still images.

Likewise disclosed according to embodiments of the instant teachings is, a business method for reducing insurance rates which comprises storing with a patient/job's record at least one image, the image being chosen from the group consisting of digital still images and digital video images. The insurance rates are then reduced due to memorialization in the image of a patient/job's condition at the time medical decisions and treatment decisions were made.

### DRAWINGS

The above-mentioned features and objects of the present disclosure will become more apparent with reference to the following description taken in conjunction with the accompanying drawings wherein like reference numerals denote like elements and in which:

FIG. 1 is a block diagram of an embodiment of an analog to digital image processing system.

FIG. 2 is a schematic of an embodiment of the path taken by an analog signal as it is digitized by the image processing system.

FIG. 3 is a block diagram of an embodiment of the formation of one or more digital output files generated from an analog signal.

### DETAILED DESCRIPTION

As used in the present disclosure, the term “network” shall be defined as a collection of interconnected computers. Accordingly, network may refer to a local area network, the internet, wide area network, virtual network, or variations on the same theme wherein data is transferred from one computer to another computer.

Since the invention of the television by Philo T. Farnsworth, human society has become increasingly image oriented. Generally, the entertainment and computer industries monopolized the applications of imaging apparatuses due to the high cost and volume of equipment needed to capture images. However, during the 1970's and 1980's, video and still photography became more generally available as the size and cost of the video and still image capture devices were reduced.

Naturally, many industries capitalized on the ability to capture images relatively cheaply. For example, in the medical industry, many procedures are minimally invasive due to the ability to doctors to insert cameras into small incisions and work solely from the images provided. Even plumbers and electricians are adopting similar technology that allow them to delve into pipes and walls holding wires, respectively. Nevertheless, despite cutting edge technology in other areas, these imaging tools remain relatively clumsy by comparison to cutting edge digital tools. Nearly all continue to rely on analog systems, despite recent advances in digital imaging systems.

At the same time, implements for capturing video have progressed far from the expensive and large original implementations. Charge-coupled devices (CCD's), active pixel sensors, fiberoptics, and other similar devices have reduced the size and cost of providing quality images. Consequently, digital imaging devices are ubiquitous in homes and businesses today. However, despite the relative abundance of digital imaging devices today, many tools used in a variety of industries lag behind in adoption of the most current digital technologies.

Thus, many imaging applications, particularly in the medical fields, rely on analog imaging devices. For example, although fiberscopes and borescopes are revolutionary devices for their ability to enter small, confined, and other inaccessible spaces, they are often analog tools. Their analog images are stored on analog storage mediums or printed in at the time of capture. However, the raw image data is generally not retained. It is accessible only in real time or stored on mediums such as magnetic tape. These types of inconveniences make analog image recording less effective. Nevertheless, many industries have not yet upgraded equipment to both capture and store digital images. Thus, there exists a need in the art for digitization of analog images.

Attempts have accomplished digitization with limited success and utility. However, no attempts to date have unharnessed the true power of digital imagery, to combine the advantages in storage and accessibility, real-time access of previously captured data, and the ability to multitask image viewing and capture. For example, to date no medical imaging devices exist that allow doctors, dentists, and veterinarians to both view live video in a minimally invasive procedure, as well as capture still images without affecting the video images. Moreover, the system of present disclosure further permits the introduction of overlays on the images. The ability to view multiple images and varied image types will prove to be a boon to users who may benefit from both types of imagery simultaneously. Moreover, doctors will have the ability to capture high quality, color digital images and video of an image feed without interrupting or freezing the video feed and allows doctors to send video to a patient's medical file, permanently memorializing the events of the procedure and the health circumstances of a given patient. These advantages make digital images the preferred format.

Prior to being stored on digital storage media, analog images must be converted to digital. Generally, this requires processing an analog image signal to digitize it. Modern day computer processors have little difficulty digitizing a feed in real-time. However, requiring the processor to accomplish parallel tasks often causes hiccups, or minor defects that slow down both processing and quality of the digital images while the processor handles multiple threads. Consequently, it is desirable to dedicate processing power to each analog image signal being digitized by dedicating a processor.

The present inventors have discovered that by dividing analog signals and dedicating hardware to each analog signal, multiple digitization events may be simultaneously accomplished, which allows the capture of both still images and video images and recordation and uploading of digitized copies of the same to locations at the same time. These captured images may be displayed on a display, stored, or both depending on the specific implementation. In industries that rely on images, such as the medical industry, the ability to multiply digitize and store the captured images makes the procedures for which the cameras are used more efficient. For example, doctors who can both capture, print, and save still images without interrupting the video signal can perform surgery using the video feed while capturing still images with the press of a button. This gives doctors the ability rely on the video image for the surgery without interruption.

As applied in the medical field, which should be understood to encompass life science related applications clinically and in the lab, the present disclosure provides a tool for providing all the advantages of digital imaging without the need to upgrade to expensive imaging hardware. Nevertheless, standardized imaging formats, such as the digital imaging and communications in medicine (DICOM) format in the medical industry, may be seamlessly integrated into the devices and methods of the present disclosure, including the applicable transfer protocols to PACS servers for storing of such images. These integrative features operate and exist in harmony with the other features and advantages discussed herein. Thus, a tool is provided that is superior to other current solutions, without the need to sacrifice tried and true industry standards or dedicate an imaging device to either video or still capture at any given time. The net results, as applied to the medical industry, are faster surgeries and diagnostics, better record keeping, and memorialization of procedures for later review and training, making the devices and methods of the present disclosure superior to other solutions.

The systems of the present disclosure provides for simultaneous file delivery of image files in multiple formats. Workflow considerations are therefore reduced due to the independence of each capture and encoding module, which operates independently from the others modules. Consequently, both still image files and video images files may be simultaneously captured and stored in a variety of user-defined formats. Capture and encoding may occur with the push of a button (e.g., a footpedal) and may be operated independently of live displays of an analog image signal, which need not be present for the system of the present disclosure to successfully operate.

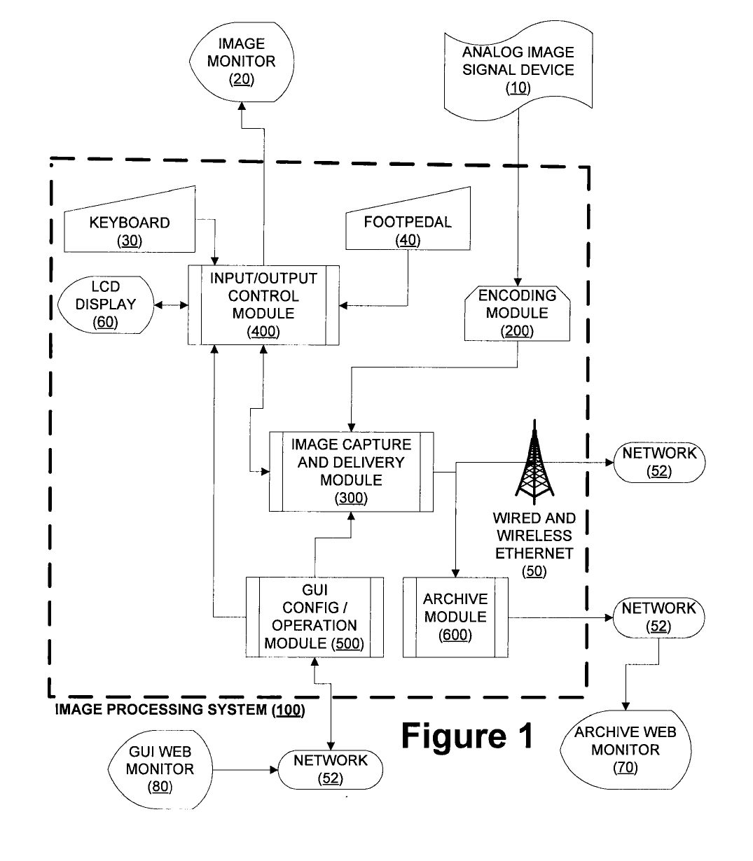

Turning now to an embodiment of the present disclosure shown in FIG. 1, there is shown the system of the present disclosure. Analog image signal device 10 produces an analog signal that is sent into image processing system 100. Analog image signal device 10 may be selected from any number of image capturing devices including still cameras, video cameras, endoscopes, borescopes, fiberscopes, and other devices that produce an analog output that would be known to a person of ordinary skill in the art. According to an embodiment, digitization of may occur from any source that produces an NTSC or PAL composite or s-video signal.

The analog signal is first received by encoding module 200, where the analog signal is converted into a digital signal. The digital signal is then processed by image capture and delivery module 300. Input/output control module 400 causes image capture and delivery module 300 to send digital signal to any number of devices. Generally, it will be understood by artisans that image capture and delivery module 300 is controlled by both input/output control module 400, and preprogrammed configuration information from graphical user interface (GUI) configuration and operation module 500.

In addition to routing data to a variety of destinations, such as image monitor 20 and LCD display 60, image capture and delivery module 300 may send the digital signal to archive module 600. According to an embodiment, archive module 600 may be configured and controlled directly or remotely over network 52 using archive web monitor 70. According to alternate embodiments, image processing system 100 interacts with archive module 600 only to send images for archival; archived images are not directly accessible. Similarly, image capture and delivery module 300 may transfer the digital signal over wired and wireless ethernet adapters 50 to other computers on network 52. The digital signal sent from image capture and delivery module 300 may either be a raw digital image or a compressed digital image file for more efficient network transfer and savings in file storage space requirements. Typically, each image file contains embedded fields with identification information, are named with a naming convention preserving identity, include an overlay with identity information, or may be identified based on other methods of preserving the identity of a particular image that would be known to a person of ordinary skill in the art.

Input/output control module 400 provides an interface from which a user may operate image processing system 100. According to the exemplary embodiment, keyboard 30 and footpedal 40 provide mechanisms by which a user may control input/output control module 400 directly. Additionally, users may specify operating parameters using GUI configuration and operation module 500. GUI configuration and operation module 500 connects via network 52 to GUI web monitor 80, which monitors and allows remote programming of operating parameters in GUI configuration and operation module 500.

Input/output control module 400 also interfaces with both image monitor 20 and LCD display 60. Image monitor 20 comprises one or more viewing monitors and receives the digital signal for displays. Image monitor 20 may display an ongoing digital video image in real time or nearly real time as captured with analog image signal device 10. Image monitor 20 may also display the raw analog signal. Image monitor 20 may also be configured to show still images or other data relevant to the task for which image processing system 100 is being used, as would be known to a person of ordinary skill in the art. According to similar embodiments, multiple image monitors 20 may be present and used to show the same or different images.

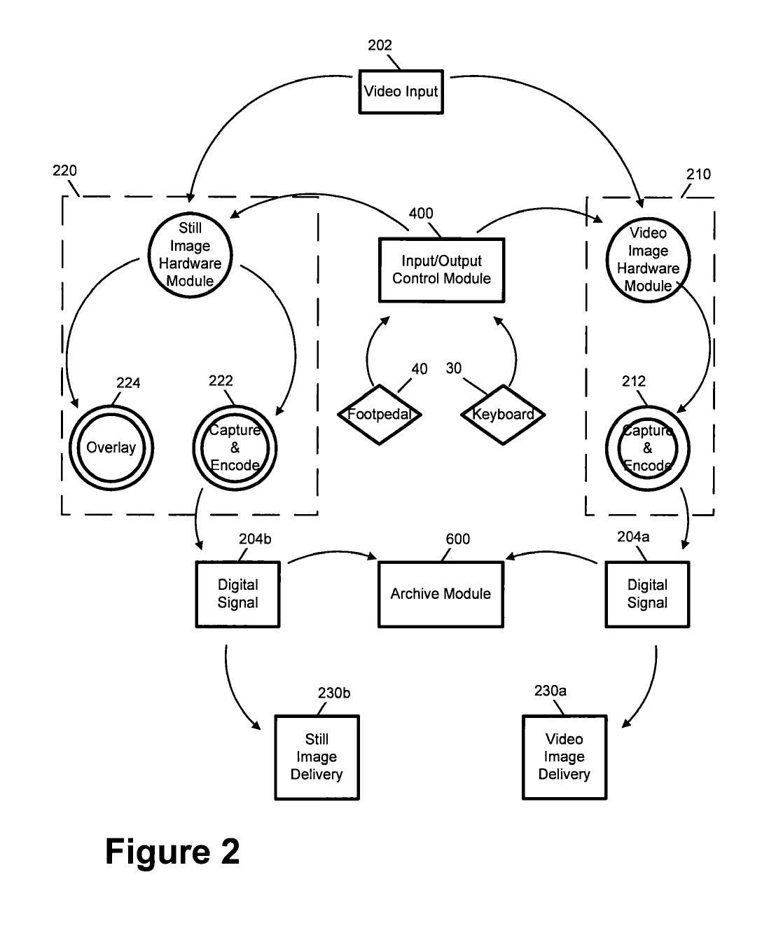

According to embodiments, input/output control module 400 also allows users to enter and view patient/job data and information. These data may be displayed on image monitor 20 or on LCD display 60, according to embodiments. Additionally, various data may be overlayed (see overlay 224 in FIG. 2) on still images to capture key demographics with each still image. The same process may also be used with video images, according to embodiments.

LCD display 60 may show a number of screens including captured digital still images, configuration information, data related to the application for which analog image signal device 10 is being used. According to alternate embodiments, LCD may perform more basic functions such as display of image processing system 100 status or identification information. According to embodiments, LCD display 60 is built into image processing system 100. For example, in an endoscopy, LCD display 60 may show one or more captured still image thumbnails; biographical data of the patient/job; the patient's circumstantial data such as heart rate, temperature, and blood pressure; surgery related data such as the time elapsed; the configuration of image processing system 100 and other relevant data as known by artisans. These data may also be displayed on image monitor 20. The exact configuration of LCD display 60 are customizable and would be appreciated and understood by a person of ordinary skill in the art. According to similar embodiments, LCD display 60 may be limited to the display various messages such as capture status, patient/job information, record information, error information, and status of image processing system 100 messages.

GUI configuration and operation module 500 is an interface where users configure and select options for image process system 100. GUI configuration and interface module 500 allows users to select storage paths, file formats, file bitrate, and file delivery options for both video and still images. Using the GUI, users may test delivery settings to ensure that files are successfully delivered to the chosen destination, according to embodiments. Artisans understand that illustration GUI configurations and systems are exemplary, and not limiting.

Moreover, according to embodiments users may assign options for the functional hardware features of input devices in GUI configuration and interface module 500. For example, users may configure what software function is accomplished when a particular footpedal 40 is pressed. Footpedal 40 may consist to a left pedal and a right pedal. The left pedal may be configured to capture a still image when pressed. The right pedal may be designed to start and stop video image capture. Allowing user definable assignment of software features, such as a capture still image function, to various hardware allows users to customize image processing system 100 according to their preferences. According to similar embodiments, GUI configuration and interface module 500 allows users do at least one of the following: to view and delete log files, access archived copies of video, and manually make copies of video and images, and combinations thereof.

According to further embodiments, GUI configuration and interface module 500 provides real time process information and allows for remote control of image processing system 100. Using GUI configuration and interface module 500, users may observe in real time to status of image processing system 100 and view status log files of prior sessions.

Finally, GUI configuration and interface module 500 comprises an administration sub-module. Within the sub-module, operation parameters for image processing system 100 may be entered, for example networking data such as IP addresses, subnet masks, and gateways, as well as user management features.

Once settings are selected and configured in GUI configuration and interface module 500, the settings are saved to a configuration file that may be read by image processing system 100, such as an XML file, text file, or database, according to embodiments. Methods of implementing a GUI and communicating settings to software is well known in the art and may implemented as would be known to a person of ordinary skill in the art, this further discussion is omitted at this time.

FIG. 2 shows an embodiment of encoding module 200. Encoding module 200 comprises one or more independent hardware encoding modules. According to the embodiment shown in FIG. 2, encoding module comprises two hardware encoding modules, video image hardware module 210 and still image hardware module 220. It will be understood by artisans that these modules may be accomplished similarly using software only solutions.

According to the embodiment shown in FIG. 2, analog signal 202 is split into dual analog signals 202, each of which are received by hardware encoding module 210, 220. Splitting of analog signal 202 may be accomplished using specialized wires, conventional splitters, and other similar implements that would be known to artisans. Additionally, analog signal 202 may be split using software solutions as well.

After splitting analog signal 202, video image hardware module 210 and still image hardware module 220 receive analog signal 202 for capture and encoding. Each hardware module 210, 220 comprise hardware that both captures and encodes analog signal 202 into digital signals 204a and 204b. Additionally, as shown in still image hardware module 220, overlay module 224 may be used to overlay data on the still image. Overlay module 224 may also be included with video image hardware module 210 according to embodiments. The hardware requirements of the embodiments shown may constitute custom made or commercially available hardware capture and encoding PCI, mini-PCI, ISA, or equivalent-type hardware solutions. Capture and encoding chips are commercially available for such applications; artisans will appreciate and know the best method to achieve the desired capture and encoding solution depending on the objectives for which image processing system 100 is built. The inventors of the present disclosure have also contemplated hardware separation of digitizing hardware (i.e., capture hardware) and encoding hardware, according to embodiments, which are known to be interchangeable with systems described herein, and with the scope of the instant claims, appended hereto.

The output from video image hardware module 210 and still image hardware module 220 are digital signals 204a and 204b. These signals are delivered to at least one delivery device 230a, 230b. Delivery device 230a, 230b can viewing monitor 20 or electronic storage devices, as known by persons of ordinary skill in the art. Digital video signal 204b may be split and sent to multiple delivery devices 230a simultaneously. Similarly, multiple digital video signals may be stored or displayed simultaneously on the same image monitor 20 or storage device.

Concurrently with the output of digital signals 204a, 204b to one or more delivery devices 230a, 230b, digital signal 204a, 204b may also be received by archive module 600 and stored on a portable storage media. Additionally, digital signals 204a, 204b may be stored on storage media built into image processing system 100. This type of storage media may retain the digital data in a raw digital format, such as MPEG-4 or bitmap, or in compressed formats, such as XviD, MPEG-2, DICOM, PNG, or JPEG. Local storage may be for indefinite periods according to certain embodiments, for set time periods according to other embodiments, or until storage space is needed according to still other embodiments. According to effective embodiments, hardware comprising both capture chips and compression chips facilitate efficient capture and encoding, with the option to preserve raw data streams either locally or remotely.

Input/output control module 400 controls the behavior of still video image hardware module 210 and image hardware module 220. Input/output control module 400 provides the hardware modules with parameters for capture, encoding, and all other hardware functions that are user configurable. Additionally, input/output control module 400 directs digital signals 204a, 204b to image monitor 20, storage media, and archiving module 600. Users interface with image processing system 100 through input devices interfacing with input/output control module 400. Input devices may include keyboard 30, footpedal 40, mice, touch screens, track balls, voice recognition algorithms, and other input devices known in the art for interface with computers.

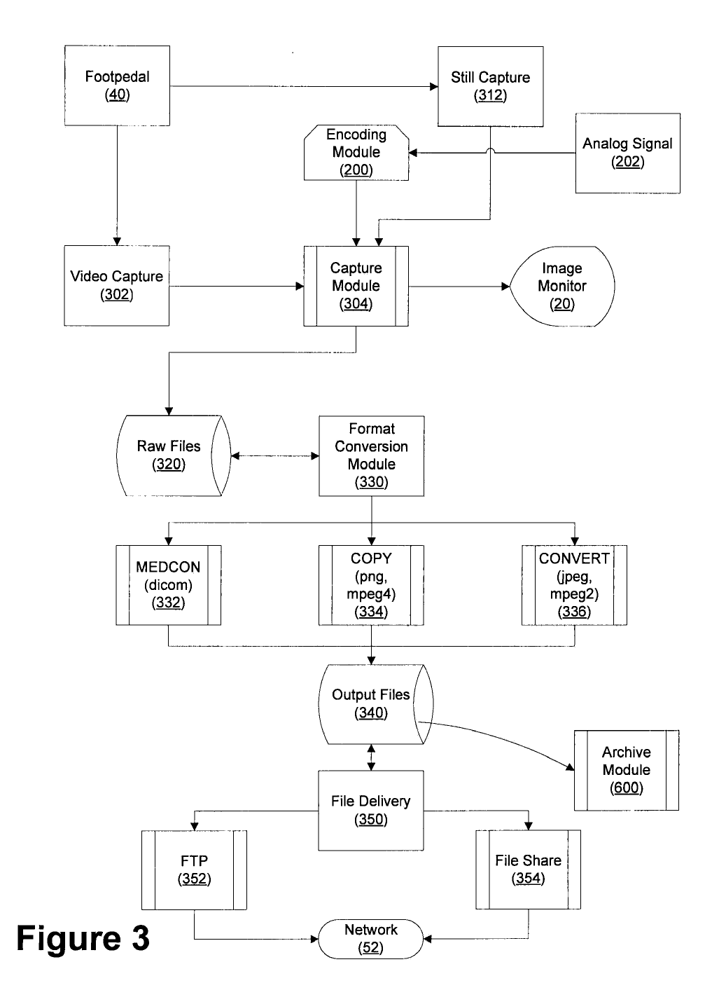

An embodiment of the process by which analog stream is converted into a digital end product, used, and delivered is shown in FIG. 3. According to the exemplary embodiments, analog signal 202 is digitized by encoding module 200 as previously described or known to a person of ordinary skill in the art. Use of footpedal 40 dictates which image streams are captured at any given time. It will be understood by a person of ordinary skill in the art that any other input device may accomplish the same objective, as well. The input device dictates to encoding module 200 which formats to digitize.

Selection of still capture 312 initiates still capture hardware module 220 (see FIG. 2) to digitize analog signal 202 as a still image. Still capture 312 initiates encoding module 200 to digitize analog signal 202 into one or more still images as of the moment that footpedal 40, according to an exemplary embodiment, is pressed. The still image may be displayed, for example, on image monitor 20 or on other work stations after the fact. Still image display software, may be any suitable software such as native Windows image viewers or MPlayer on unix- and linux-based systems.

Likewise, footpedal 40 or other input device may also initiate video capture 302. Like still capture 312, initiation of video capture 302 causes encoding module 200 and digitize video images with image hardware module 210, which are captured with capture module 304, which may be hardware or software based as known by artisans. Like still images, the video images are captured as a raw file 320 and may also be outputted to image monitor 20. According to other embodiments, analog signal 202 is displayed on image monitor 20. In this type of configuration of image processing system 100, video digitization and capture is captured solely as raw file 320 for storage. Captured digitized video may be viewed after capture on terminals with access to the video image files.

Likewise, according to the exemplary embodiment of FIG. 3, the still image or video image may also by stored on the local system as raw file 320. Raw file 320 is used for a number of purposes: compression, temporary archives, and may itself be delivered as output file 350. Raw file 320 is stored in local storage media. Raw file 320 may also be stored on network computers or removable storage, if desired and image processing system 100 is so configured.

In an exemplary embodiment, still image raw file 320 is a portable networks graphics (PNG) file. Bitmap images may also be used or other lossless formats, as would be known to persons of ordinary skill in the art. Similarly, video image raw file 320 is moving pictures experts group standard 4 (MPEG-4) file. Although technically a compressed video format, the quality of the MPEG-4 file may be set to a high bitrate comparable to DVD or exceeding DVD quality pictures. Naturally, other video formats are equally effective including MPEG-2, variously lossless video compression techniques, and others that would be known and understood by a person of ordinary skill in the art.

Because in many cases transfer of raw image files is impractical both from a bandwidth standpoint as well as a storage space consideration standpoint, format conversion module 330 may processes raw file 320 and convert raw file 320 into any number of compressed counterpart files. Conversion may occur in real time or processed when processing power is available for conversion. The parameters defining the time of conversion, type of conversion, and bitrate of the conversion, among other relevant factors are known to persons of ordinary skill in the art, and are defined on a per-user basis in GUI configuration and operation module 500. Similarly, input/output control module 400 further defines and controls format conversion module 330 and delivery of the image files.

Within format conversion module 330, raw files 320 may be converted to any number of file formats, as would be know to artisans. For example, according to the exemplary embodiment, each video raw file 320 may be converted to MPEG-2, a lower bitrate MPEG-4 file, or copied “as is” to another location. Similarly, still image raw files 320 may be compressed to JPEG, TIF, DICOM, and other compressed image files. Like the video files, still image raw files 320 may also be copied in the raw format or recompressed to a lower bitrate in the same file format.

After file conversion module 330 prepares output file 340, file delivery 350 occurs. According the embodiment shown in FIG. 3, file delivery 350 is accomplished by file transfer protocol 352 or fileshare service 354, such as Windows fileshare, Appleshare, or Samba. Similarly, internet protocols such as hyper text transfer protocol may be used, as well as nearly any other protocol suitable for transfer of image files, such as DICOM protocol for DICOM images. As such, many suitable file delivery 350 mechanisms exist in the art and are known to artisans; these may be used in addition to or replace one or more of the services disclosed herein. Moreover, file delivery is not constrained solely to delivery by network 52, but may be facilitated by copy of output file 340 to portable storage media such as CD, DVD, magneto-optical, floppy disk, flash-memory-based devices, portable hard drives, and other portable storage media solutions that would be known to a person of ordinary skill in the art. These services connect image processing system 100 with other computers on network 52 and provide for efficient and convenient transfer of output files 340 to the other computers on network 52.

Likewise presented herein is a novel method for providing an image processing system 100. The system is as described herein, and comprises a plurality of hardware modules that convert an analog signal to a digital signal. These signals are then used for to capture of still images and video images. According to embodiments, these images are useful in medical, dental, veterinary, and other applications (e.g., plumbing) that rely on analog image capturing devices. Using the method provides doctors, dentists, veterinarians, and others, for example, with tools capturing and storing digital images in various formats. Using the digital images captured, patient/job files are more complete, a more comprehensive record is stored, complete with color images and color video footage of procedures for later review. Moreover, because the images are stored in a digital format, they may be copied to a number of portable storage media devices, such as flash memory, floppy disk, CD, or DVD and stored with the patient/job's file, in addition to being archived on a hard disk, according to embodiments.

Similarly, a business method is disclosed for storing records complete with images. According to the method, images captured and digitized may be stored on many forms of portable media, as previously described. Using portable electronic media to store digital images dispenses with or augments the need to print and store hard copies of the images with physical records. For example, x-ray films are bulky and often large, which makes them difficult to store in typical medical files. Moreover, the multiplicity of films in aggregate in a typical medical, dental, or veterinary practice necessitates a large amount of otherwise unnecessary storage. The ability to save digital copies of images captured with imaging devices minimizes the amount of space necessary.

Additionally, the methods of the present disclosure provide a convenient way for doctors to store images with the patient/job's file that contain more information than the industry norms. For example, still shots are generally stored by industry norm in the DICOM format, which is a black and white format. Preserving color in images preserves aspects in the images that would otherwise be unseen in black and white images. More importantly, however, the present disclosure provides a tool for preserving images a much higher resolution, which also serves to preserve more information. Finally, preserving video records provides an additional avenue of information preservation not currently available in most traditional record databases.

By increasing the level of information in files in the medical industries, in particular, doctors, dentists, and veterinarians stand to benefit from reduced malpractice insurance rates. Because a variety of information may be stored, essentially recording the basis for diagnosis and suggested treatments, doctors have the ability to justify their decisions, in the event the diagnosis or suggested course of treatment is later called into question. Multiple color images and video images provide insurance companies with an audit mechanism which allows adjusters to more accurately gauge the value of insurance claims and screen for frivolous claims. The net result provides a basis for reduction of insurance rates offered to doctors, dentists, and veterinarians, without interfering with current practice or procedures and without the need to upgrade industry standard components with digital components.

While the apparatus and method have been described in terms of what are presently considered to be practical embodiments, it is to be understood that the disclosure need to be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims, and their equivalents.

1. A device comprising, in combination:
an analog image signal;
an analog to digital converter;
at least one still image capturer;
at least one video image capturer;
wherein the still images and video images may be independently and simultaneously captured, digitized, and stored.

2. The device of claim 1, further comprising:
at least one hardware module for still image analog to digital conversion and capture resulting in at least one digital still image file;
at least one hardware module for video image analog to digital conversion and capture resulting in at least one digital video image file;
wherein the analog signal is split into a plurality of analog signals that feed each hardware module.

3. The device of claim 1, further comprising a footpedal.

4. The device of claim 3, wherein a user may induce capture of still images with a footpedal.

5. The device of claim 1, further comprising at least one display.

6. The device of claim 5, wherein the at least one display is a plurality of displays; and
wherein at least one first display is dedicated to still images and at least one second display is dedicated to video images.

7. The device of claim 1, wherein the parameters of the device are input with a graphical user interface.

8. The device of claim 7, wherein the graphical user interface is available to a user over a network.

9. The device of claim 1, wherein the device is used for the purposes of medical related imaging.

10. The device of claim 9, wherein the device is used during surgical procedures.

11. The device of claim 2, further comprising a file converting module for conversion of the at least one digital still image file or the at least one digital video file into a compressed format.

12. The device of claim 11, wherein at least one of a digital still image file, compressed digital still image file, digital video file, or compressed digital image file is stored as a medical record.

13. The device of claim 12, wherein compressed digital still image file or at least one compressed digital video file is copied to a permanent storage media.

14. A video capture system comprising, in combination:
an analog image signal;
an analog to digital converter;
at least one still image capturer;
at least one video image capturer;
at least one hardware module for still image analog to digital conversion and capture resulting in at least one digital still image file;
at least one hardware module for video image analog to digital conversion and capture resulting in at least one digital video image file;
at least one display;
wherein the still images and video images may be independently and simultaneously captured, digitized, and stored;
wherein the analog signal is split into a plurality of analog signals that feed each hardware module.

15. The system of claim 14, wherein at least one first display is dedicated to still images and at least one second display is dedicated to video images.

16. The system of claim 14, further comprising a foot petal.

17. A method comprising:
providing a digital to analog image converter, the converter accepting a analog signal and converting it into a plurality of digital signals;
wherein at least one digital signal is used for video images; and
wherein at least one digital signal is used for still images.

18. The method of claim 17, wherein the method is used medical, dental, or veterinary applications.

19. The method of claim 17, wherein the method allows a user using an analog image capturing device producing the analog signal, the user using the analog device to image spaces inaccessible viewing by a human.

20. A business method for storing records comprising:
storing at least one image with a record;
storing at least the at least one image in an archive;
wherein the at least one image is a still image, a video image, or combinations thereof.

21. The business method of claim 21, wherein the records are one of medical records, dental records, or veterinary records.

22. The business method of claim 21, wherein the archive comprises an electronic storage medium.

23. The business method of claim 22, wherein at least one of a still image and a video image is transferred to a portable storage media and stored with a patent file.

24. A business method for reducing insurance rates comprising:
storing with a patient's record at least one image, the image being chosen from the group consisting of digital still images and digital video images;
wherein the insurance rates are reduced due to memorialization in the at least one image of a patient's condition at the time medical decisions and treatment decisions were made.

25. The method of claim 24, further comprising:
storing a plurality of images.

26. The method of claim 25, wherein the images are stored on a portable electronic storage media.
